(19) United States
(12) Patent Application Publication
(10) Pub. No.: US 2002/0052940 A1
(43) Pub. Date: May 2, 2002

(54) Method and system for using wireless devices to control one or more generic systems

(76) Inventors: Jenny Myers, Providence, RI (US); Jim Higgins, N. Kingstown, RI (US)

Correspondence Address: MINTZ, LEVIN, COHN, FERRIS,, GLOVSKY and POPEO, P.C, One Financial Center, Boston, MA, 02111, US

(21) Appl. No.: 09/854,870

(22) Filed: May 14, 2001

Related U.S. Application Data
(60) Provisional application No. 60/243,953, filed on Oct. 27, 2000.

(30) Foreign Application Priority Data
May 14, 2001 (US) 09854870

(51) Int. Cl. G06F 15/16; G06F 15/173; G06F 1/30

(52) U.S. Cl. 709/223; 709/224; 713/310; 709/218

(57) ABSTRACT

A generic system adapted to receive control, configuration and status information from a plurality of wireless devices over a communication system. The generic system includes an input adapted to receive power from a primary power source. An output controller is coupled to the input and to a plurality of outputs. The generic system further includes a network interface adapted to receive the control, configuration and status information from the plurality of wireless devices over the communication system and for generating a plurality of signals. A processor is coupled to the network interface and to the output controller. The processor is adapted to receive and process the plurality of signals provided by the network interface for generating a plurality of control signals. The output controller is adapted to receive and respond to the control signals, which are provided by the processor, by selectively powering-on or powering-off the plurality of outputs to selectively provide power to a plurality of equipment or components.

### RELATED APPLICATION

This application claims priority to U.S. Provisional Patent Application Ser. No. 60/243, 953, filed Oct. 27, 2000.

### FIELD OF THE INVENTION

The present invention relates generally to a method and system for using wireless devices to control one or more generic systems, and more specifically to a generic system that is adapted for communicating with one or more wireless devices over a computer network to enable the wireless devices to provide control and configuration information to the generic system.

### BACKGROUND

The Internet and World Wide Web (“Web”) are rapidly becoming commonplace tools for the achievement of a wide variety of tasks and the accessibility of multitudes of information. This growth is predicted to continue as Web functionality and access to it grows and improves. As part of this growth, there is a steady migration of Web functionality to an increasing range of wired and wireless computers and electronic devices. A large portion of this Web functionality includes the migration of traditional business models to a Web-based business model.

As an example, Web-based applications can facilitate interactions (e.g. transactions) related to the procurement of goods and/or services over the Web, broadly referred to as electronic commerce or “e-commerce” applications. Depending on the particular application, these interactions are often categorized as business-to-consumer, business-to-business, or consumer-to-consumer. As examples, airline tickets, hotel reservations, food, clothing, event tickets, memberships, commodities, commercial supplies, perishable goods and so forth may be procured over the Web with a credit card or other payment means.

In particular, the wireless service market is becoming increasingly popular, because this service market can provide subscribers with up-to-date information on stocks, sports, news, and the like. There are many wireless devices used in the wireless service market today, including mobile telephones, pagers, personal digital assistants (PDAs) and other wireless terminals, hereinafter collectively referred to as “wireless devices.”

Conventional wire-line techniques and protocols for Internet access have been tried in wireless systems, but have encountered problems. The technique of requesting a single Web page (or portion of a page) and then displaying the page (or portion of the page) before requesting another page (or another portion of the same page), as currently used in the wire-line protocols, can introduce excessive latency in wireless systems. This is because such systems queue each response until adequate air time becomes available to transmit the response.

The Wireless Application Protocol (“WAP”), has addressed the latency problem described above by sending multiple Web pages, for example, in a single transmission as a “deck” of “cards,” each card corresponding to a page of structured content and navigation specifications. The Wireless Application Protocol enables sophisticated telephony and information services on handheld wireless devices. Recognizing the value and utility of the World Wide Web architecture, the WAP has chosen to align its technology closely with the Internet and the Web. The WAP specification extends and leverages existing technologies, such as digital data networking standards, and Internet technologies, such as IP, HTTP, XML, SSL, URLs, scripting and other content formats.

To the greatest extent possible, the WAP uses existing industry standards as the basis for its own architecture and design. For example, a WAP Gateway is required to communicate with other Internet nodes using the standard HTTP 1.1 protocol. Furthermore, WAP calls for wireless devices to use the standard URL addressing scheme to request services.

At present and as generally described above, wireless devices have been used to (1) receive basic information via the internet, (2) for communication such as sending email, and (3) to effect transactions such as financial transactions or reservations. However, in order to extend the utility of wireless services, a need exists for a system and method for using a wireless device to control and manage equipment, such as a power supply system.

### SUMMARY OF THE INVENTION

An object of the present invention is to set forth a generic system that is adapted to receive and respond to control, configuration and status information provided by one or more wireless devices to actuate an actuator, which is associated with the generic system, to power-on or power-off a plurality of equipment and/or components that are coupled to the generic system.

Another object of the present invention is to set forth a method of controlling the generic system to control the plurality of equipment and/or components, which are coupled to the generic system.

In accordance with aspects of the present invention, a generic system is set forth that is adapted to receive control, configuration and status information from a plurality of wireless devices over a communication network. The generic system includes an input adapted to receive power from a primary power source. The generic system further includes an output controller, which is coupled to the input and to a plurality of outputs.

The generic system further includes a computer network interface adapted to receive the control, configuration and status information from the plurality of wireless devices over the communication network. The network interface generates a plurality of signals representing the control, configuration and status information.

A processor is coupled to the network interface and to the output controller. The processor is adapted to receive and process the plurality of signals provided by the network interface for generating a plurality of control signals. The output controller receives and responds to the control signals, which are provided by the processor, by selectively powering-on or powering-off the plurality of outputs to selectively provide power to a plurality of equipment.

The network interface further includes Wireless Mark-Up Language protocol that enables the network interface to receive the control, configuration and status information from the plurality of wireless devices over the communication network. In addition, the network interface can include Simple Network Management protocol that enables the network interface to receive the control, configuration and status information from a plurality of servers.

In one aspect of the invention, the generic system includes an uninterruptible power supply system and further includes a secondary power source adapted to provide secondary power to the plurality of equipment. A control switch is coupled to the primary power source, secondary power source and the plurality of equipment. The control switch is further coupled to the controller or processor. A sensing circuit is coupled to the input and is adapted to detect if the primary power source is below a predetermined threshold. If the sensing circuit detects that the primary power source is below the predetermined threshold, the sensing circuit provides a first signal to the controller or processor. In response to the first signal provided by the sensing circuit, the controller or processor provides a first actuation signal to the control switch to actuate the control switch to enable the secondary power source to provide power to the plurality of equipment.

If the sensing circuit detects that the primary power source is above the predetermined threshold, the sensing circuit provides a second signal to the controller or processor. In response to the second signal provided by the sensing circuit, the controller or processor provides a second actuation signal to the control switch to actuate the control switch to enable the primary power source to provide power to the plurality of equipment.

In another aspect of the invention, the generic system includes an intelligent power strip and further includes an elongated housing. A plurality of power outlets is mounted on the housing. The power outlets define the plurality of outputs that are adapted to provide power to the plurality of electrical equipment.

In another aspect of the present invention, a method of controlling the generic system comprises the steps of receiving control, configuration and status information at the generic system; generating a plurality of control signals at the generic system representing the control, configuration and status information; and communicating the plurality of control signals to a plurality of outputs located on the generic system to selectively actuate the outputs to selectively power-on or power-off a plurality of equipment and/or components, which are coupled to the plurality of outputs.

### BRIEF DESCRIPTION OF THE DRAWINGS

The foregoing and other objects of this invention, the various features thereof, as well as the invention itself, can be more fully understood from the following description when read together with the accompanying drawings in which:

FIG. 1a is an exemplary communication system for enabling a plurality of wireless devices to communicate with a plurality of generic systems;

FIG. 1b is a simplified functional block diagram of one of the generic systems shown in FIG. 1a;

FIG. 2 is an intelligent power strip exemplifying one generic system, which is adapted for use within the system shown in FIG. 1a; and

FIG. 3 is an uninterruptible power supply system exemplifying another generic system, which is adapted for use within the system shown in FIG. 1a.

### DETAILED DESCRIPTION OF THE PREFERRED EMBODIMENTS

In the following detailed description of the present invention numerous specific details are set forth in order to provide a thorough understanding of the present invention. However, it will be obvious to one skilled in the art that the present invention may be practiced without these specific details. In other instances, well known methods, procedures, components, and circuits have not been described in detail as not to unnecessarily obscure aspects of the present invention.

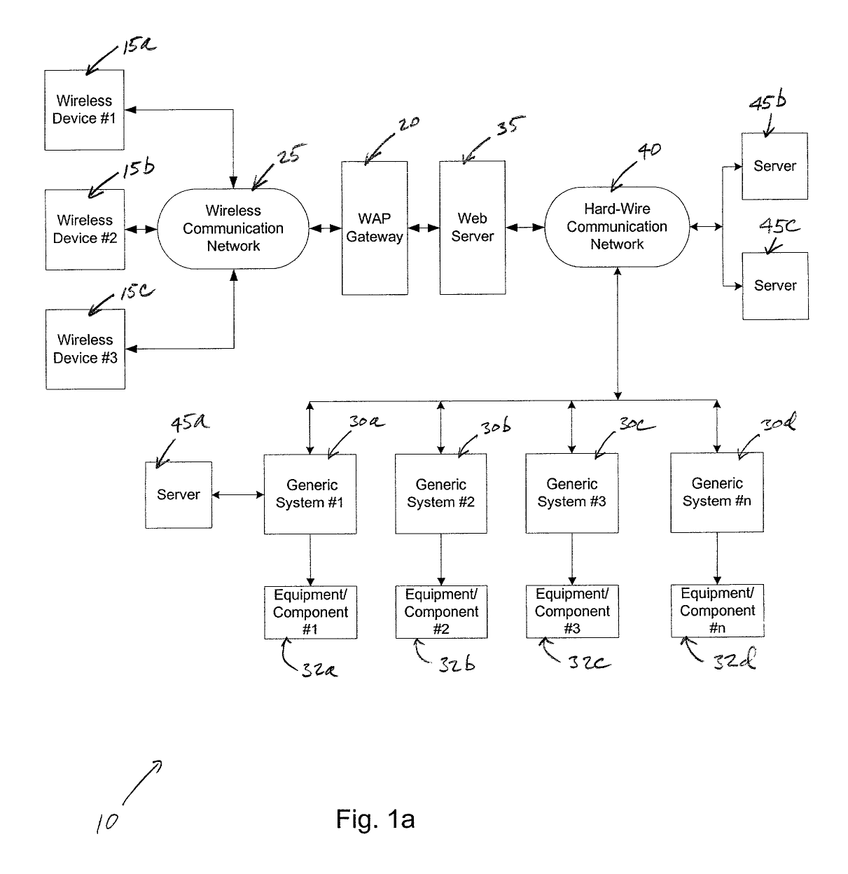

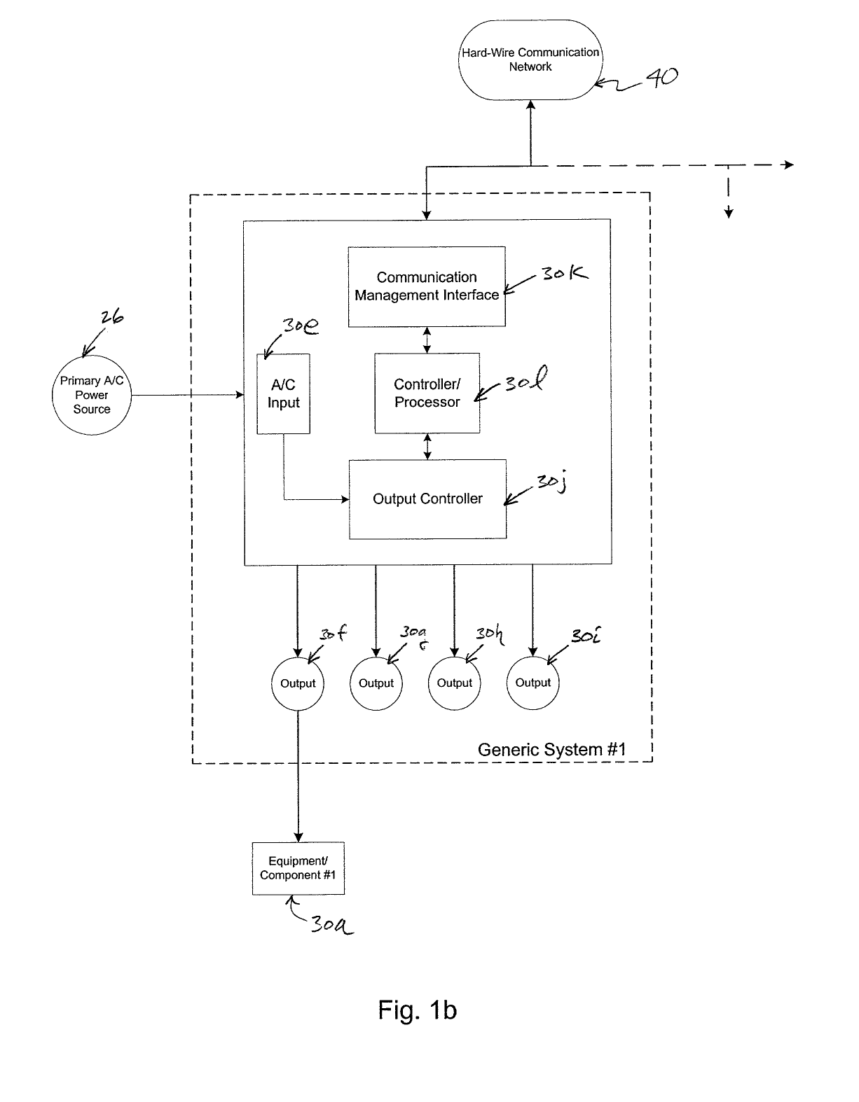

Referring to FIG. 1a, in accordance with an embodiment of the present invention, a communication system 10 and method for using one or more wireless devices to control, configure and manage equipment over the communication system 10 is set forth. More precisely, the communication system 10 according to the present invention includes a plurality of wireless devices 15a, 15b and 15c coupled to a WAP gateway 20 via a wireless communications system 25 (i.e. cellular communications network). The communication system 10 further includes a plurality of generic systems 30a, 30b, 30c, and 30d, (hereinafter collectively referred to as “generic system(s) 30”) coupled to a Web server computer 35 via a hard-wire communications network 40, such as the Internet. The generic systems 30 are each coupled with one or more units of electrical equipment and/or components 32a, 32b, 32c and 32d, as shown in FIG. 1a.

Optionally, one or more of the generic systems 30 can be coupled to a server either directly or via the hard-wire communication network 40. In an example and as shown in FIG. 1a, the server 45a is coupled directly to the generic system 30a for locally communicating control, configuration and status information to the generic system 30a. The servers 45b and 45c are coupled to the power systems 30, via the hard-wire communication network 40, for remotely communicating control, configuration and status information to any one of the generic systems 30.

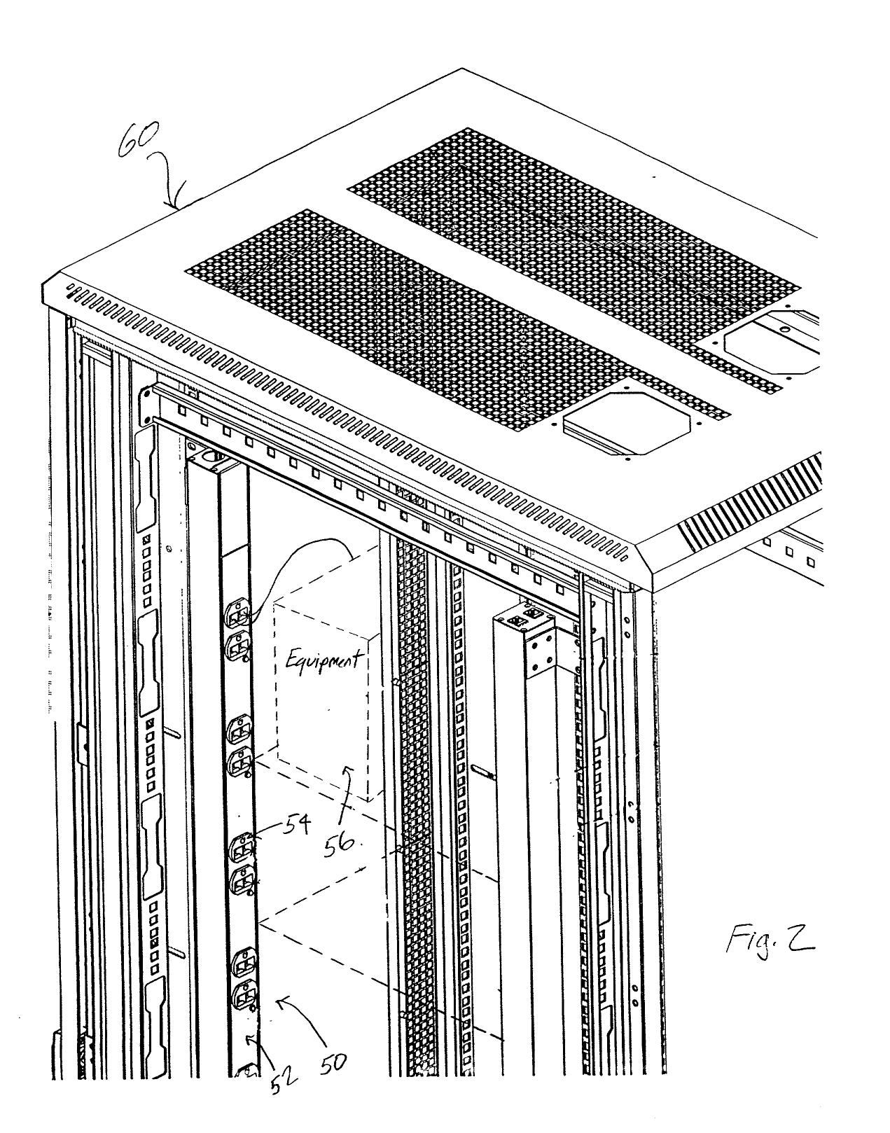

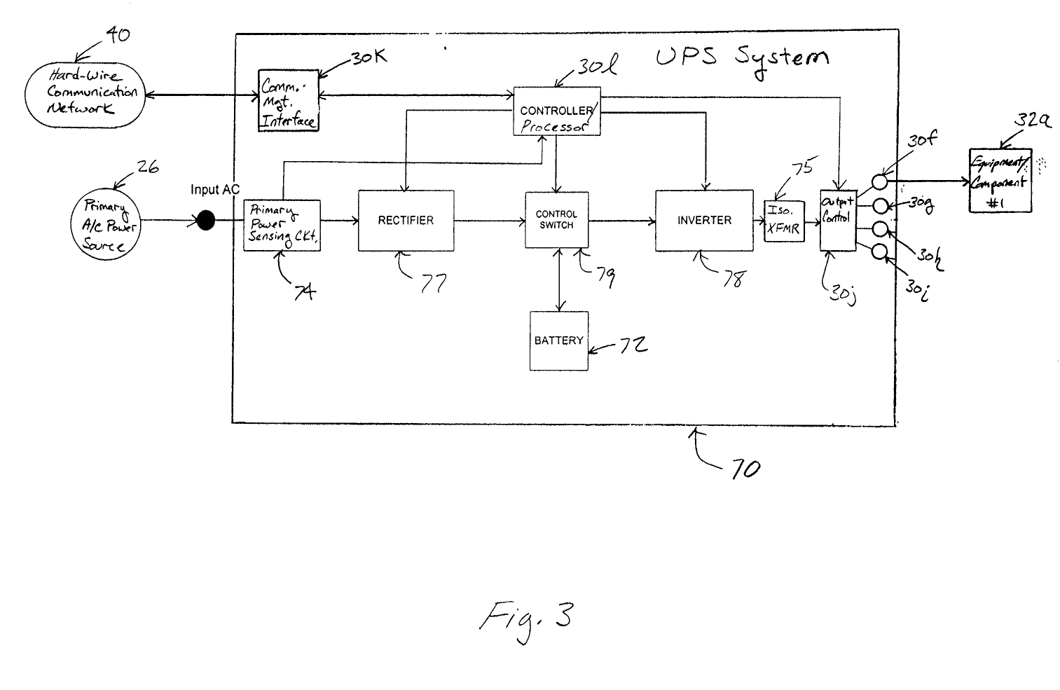

In various embodiments, the generic systems (30) can include any combination of WAP enabled commercial and/or household devices and equipment, such as power supply systems, computers, peripheral devices, machines, garage door openers, thermostats, lighting control systems, alarm systems, as well as a number of other actuator controlled devices, equipment and systems. Additionally, the generic systems (30) can include any combination of WAP enabled intelligent power strips 50 and/or an uninterruptible power supply (“UPS”) 70, which will be respectively described below with respect to FIGS. 2 and 3.

The WAP gateway 20, Web server 35 and generic systems 30 are adapted for communicating information back and forth between each other in accordance with a predetermined protocol such as HTTP. The WAP gateway 20 communicates information back and forth between itself and one or more of the wireless devices 15a, 15b and/or 15c in accordance with a predetermined protocol such as wireless markup language (“WML”). Although not shown, the Web server 35 and WAP gateway 20 can be defined on a single computer system or distributed over several computer systems to promote scalability of the system 10.

The wireless devices 15a, 15b and/or 15c, as previously mentioned, can include a plurality of WAP enabled devices, such as wireless computers, personal digital assistants (“PDAs”), pagers, cell phones and/or Web enabled televisions.

The Web server 35 can include one or more conventional computer servers such as IBM PC compatible Windows NT based servers available from Compaq Computer Corp., Houston, Tex., running Windows NT server and Internet Information Server available from Microsoft of Richmond, Wash., Sun Solaris based Servers available from Sun Micro Systems of Palo Alto, Calif. and/or LINUX based Servers running LINUX distributed by Red Hat of Durham, N.C. These computer servers can be programmed with conventional web-application software such as: J2EE or other web applications.

The WAP gateway 20 can also include one or more conventional computer servers similar to that described above. The WAP gateway 20 can further include WAP software that is based on a WAP architecture. The WAP architecture defines a functional user interface protocol that is appropriate for wireless devices 15a, 15b and/or 15c. Users of wireless devices 15a, 15b and/or 15c can navigate through cards with up and down scroll keys instead of a mouse. Soft keys allow the user of the wireless device 15a, 15b and/or 15c to perform specific operations appropriate to the application context, or select menu options. A traditional 12-key phone keypad (not shown), which is defined on the wireless device 15a, 15b and/or 15c, can be used to enter alphanumeric characters, including a full set of standard symbols. Depending on the manufacturer of the wireless devices 15a, 15b and/or 15c, the wireless devices 15a, 15b and/or 15c can include a variety of navigation functions, such as Back, Home, and Bookmark. The navigation functions are provided on the wireless devices 15a, 15b and/or 15c in accordance with a standard WAP micro-browser model. By using the existing Internet model as a starting point, this user interface provides familiar functionality for those accustomed with the Web. It also provides a user interface that is easy to learn and highly discoverable for the first time user.

The WAP micro-browser, which is incorporated into the wireless device 15a, 15b and 15c, allows devices 15a, 15b and 15c with larger screens and more features to automatically display more content, just as a traditional browser does on a PC when the browser window is expanded on screen. Generally, the WAP architecture uses standard Web proxy technology to connect the wireless domain with the Web.

The WAP gateway 20 can further include a protocol gateway, content encoders and decoders. The protocol gateway translates requests from a WAP protocol stack to the WWW protocol stack (HTTP and TCP/IP). The content encoders translate Web content into compact encoded formats to reduce the size and number of packets traveling over the wireless data network or system 25. This infrastructure ensures that wireless device 15a, 15b and 15c users can browse a variety of WAP content and applications regardless of the wireless network they use. Additionally, the WAP gateway 20 decreases the response time to the wireless device 15a, 15b and/or 15c by aggregating data from different servers on the Web, and caching frequently used information.

The wireless communications system 25 can include a number of conventional base stations and antennas. The base stations cooperate with the antennas to communicate with the wireless devices 15a, 15b and/or 15c utilizing conventional radio frequency (RF) techniques, and are coupled by conventional communication links to the WAP gateway 20, which controls the base stations.

The hard-wire communication network 40 can be any one of a number of conventional network systems, utilizing, for example, well known local area network (LAN) technologies such as Ethernet or Token Ring technologies, or wide area network (WAN) technologies such T1, ISDN, ATM, Frame Relay, FDDI technologies. The communication network 40 can also be a network of networks, for example based upon TCP/IP such as the Internet. The communication network 40 can include functionality for interconnecting one or more wireless devices 15a, 15b and/or 15c with one or more of the generic systems 30, such as the intelligent power strip 50 (FIG. 2) and/or the UPS 70 (FIG. 3). The communication network 40 can also include functionality for transferring data between the wireless devices 15a, 15b and/or 15c and the generic systems 30.

FIG. 1b shows a simplified functional block diagram of the generic system 30a, as shown in FIG. 1a. The remaining generic systems 30b, 30b and 30d are similarly constructed and arranged. In FIG. 1b, the generic system 30a includes an alternating current “AC” input 30e (hereinafter “input 30e”) adapted to receive input power from a primary AC power source 26 (hereinafter “power source 26”). The input 30e is coupled to a plurality of AC outputs 30f, 30g, 30h and 30i (hereinafter “outputs 30f, 30g, 30h and 30i”), via an output controller 30j.

The generic system 30a further includes a computer network interface 30k (hereinafter “communication management interface”), which is adapted to receive the control, configuration and status information from any one of the plurality of wireless devices 15a, 15b or 15c over the wire-less communication network 25, WAP gateway 20, Web server 35 and hard-wire communication network 40. The communication management interface 30k is further adapted to receive the control, configuration and status information locally from the server 45a or remotely from servers 45b or 45c over the communication network 40.

The communication management interface 30k processes the control, configuration and status information and generates a plurality of signals representative of the control, configuration and status information. The signals are provided to a controller or processor 301, which is coupled to the communication management interface 30k, for further processing. The controller or processor 301 generates a plurality of output control signals, which are further representative of the control, configuration and status information. The output control signals are provided to the output controller 30j, which is coupled to the processor 301. In response to the output control signals received from the processor 301, the output controller 30j actuates a plurality of switches (not shown) to selectively power-on or power off each of the outputs 30f, 30g, 30h or 30i. The plurality of switches can include a number of relays or solid state switches.

Referring further to FIG. 2, in an embodiment, the generic systems 30 of FIG. 1a each include an intelligent power strip 50. The intelligent power strip 50 is adapted for mounting in an equipment cabinet 60, as shown in FIG. 2.

The intelligent power strip 50 includes an elongated housing 52 having a plurality of controllable power outlets 54 mounted thereon. The power outlets 54 are coupled with the output controller 30j (FIG. 1b), which control the power outlets 54 to selectively power-on and/or power-off the outlets 54, in a similar manner as previously described above with respect to powering-on or powering-off the outputs 30f, 30g, 30h or 30i (FIG. 1b). A variety of equipment 56, such as computers and peripheral devices can be coupled to the power outlets 54, which provides electrical power to the equipment 56. The intelligent power strip 50 can be adapted for duplex communication with one or more of the wireless devices 15a, 15b and/or 15b, via the hard-wire communication network 40, Web server 35, WAP gateway 20 and wireless communication network 25 in accordance with the predetermined protocols described above. In this embodiment, information received by the intelligent power strip 50 from one or more of the wireless devices 15a, 15b and/or 15b can include the control, configuration and status information as previously described, which enables the intelligent power strip 50 to power-on or power-off the power outlets 54 defined on the power strip 50. Ultimately, powering-on or powering-off the power outlets 54 controls electrical power provided to the equipment 56, which is coupled to the power outlets 54. The intelligent power strip 50 can also provide status information to one or more of the wireless devices 15a, 15b and/or 15b.

Referring to FIGS. 1a, 1b and 3, in another embodiment, the generic systems 30 each include a UPS 70. In addition to the elements described above for the generic systems 30, the UPS includes a secondary power source 72, such as a battery, that provides secondary power to the plurality of equipment 32a, 32b, 32c and/or 32d (FIG. 1a). A control switch 79 is coupled to the primary power source 26, secondary power source 72 and the plurality of equipment 32a, 32b, 32c and 32d (via other various components). The control switch 79 is further coupled to the controller or processor 301. A sensing circuit 74 is coupled to the input 30e (FIG. 1b) and is adapted to detect if the primary power source 26 is above or below a predetermined threshold. If the sensing circuit 74 detects that the primary power source 26 is below the predetermined threshold, the sensing circuit 74 provides a first signal to the controller or processor 301. In response to the first signal provided by the sensing circuit 74, the controller or processor 301 provides a first actuation signal to the control switch 79 to actuate the control switch to enable the secondary power source 72 to provide power to the plurality of equipment and/or components 32a, 32b, 32c and 32d.

If the sensing circuit 74 detects that the primary power source 26 is above the predetermined threshold, the sensing circuit 74 provides a second signal to the controller or processor 301. In response to the second signal provided by the sensing circuit 74, the controller or processor 301 provides a second actuation signal to the control switch 79 to actuate the control switch to enable the primary power source 26 to provide power to the plurality of equipment and/or components 32a, 32b, 32c and 32d.

The UPS system 70 further includes a rectifier circuit 77, which is adapted to receive an input power signal from the primary source 26, via the sensing circuit 74. The rectifier circuit 77 converts the input power signal to a plurality of direct current (“DC”) power values. An inverter circuit 78 coupled to the rectifier circuit 77, via the control switch 79, is adapted to receive the plurality of DC power values and to convert the DC power values back to a power signal, which is similar to the input power signal. The power signal, which is initially provided by the primary power source 26, is provided to the plurality of equipment and/or components 32a, 32b, 32c and/or 32d, via the output controller 30j and outputs 30f, 30g, 30h or 30i.

Optionally, an isolation transformer 75 can be coupled intermediate the inverter circuit 78 and the output controller 30j for conditioning the power signal, which is ultimately provided to the equipment and/or components 32a, 32b, 32c and/or 32d.

The UPS 70 can be adapted for duplex communication with one or more of the wireless devices 15a, 15b and/or 15b, via the hard-wire communication network 40, Web server 35, WAP gateway 20 and wireless communication network 25 in accordance with the predetermined protocols described above. In this embodiment and again similar to that described above, information received by the UPS 70 from one or more of the wireless devices 15a, 15b and/or 15b can include control, configuration and status information, which enables the UPS 70 to selectively power-on or power-off one or more of the outputs 30f, 30g, 30h and/or 30i. Selectively powering-on or powering-off one or more of the outputs 30f, 30g, 30h and/or 30i also selectively powers-on or powers-off the plurality of equipment and/or components 32a, 32b, 32c and/or 32d, which are coupled to the outputs 30f, 30g, 30h and/or 30i.

The control, configuration and status information received by the UPS 70 can be further used to execute operating instructions related to the control, configuration and status information. The UPS 70 can also provide operating status information to one or more of the wireless devices 15a, 15b and/or 15b over the communication system 10 (FIG. 1a).

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting.

What is claimed is:

1. A system, comprising:
an input that receives power from a primary power source;
a plurality of outputs coupled to the input, the plurality of outputs being adapted to provide power to a plurality of equipment;
a network interface adapted to receive control, configuration and status information from a plurality of wireless devices and to generate a plurality of control signals representing the control, configuration and status information; and
a processor coupled to the network interface and to the plurality of outputs, the processor being adapted to receive and respond to the plurality of control signals by actuating the plurality of outputs.

2. The system of claim 1, further including an output controller coupled between the input and the plurality of outputs, the output controller being further coupled between the processor and the outputs.

3. The system of claim 2, wherein the output controller includes a plurality of switches coupled to the input, to the plurality of outputs and to the processor.

4. The system of claim 1, wherein the network interface operates using a Wireless Mark-Up Language protocol that enables the network interface to receive the control, configuration and status information from the plurality of wireless devices.

5. The system of claim 1, wherein the network interface operates using a Simple Network Management protocol that enables the network interface to receive the control, configuration and status information from a plurality of servers.

6. The system of claim 2, further including an uninterruptible power supply system comprising:
a secondary power source adapted to provide power to the plurality of equipment;
a sensing circuit coupled to the input to detect if the primary power source is below a predetermined threshold; and
a control switch adapted to couple the secondary power source to the plurality of equipment if the sensing circuit detects that the primary power source is below the predetermined threshold.

7. The system of claim 2, further including an intelligent power strip comprising:
an elongated housing; and
a plurality of power outlets mounted on the housing, the plurality of power outlets defining the plurality of outputs adapted to provide power to the plurality of electrical equipment.

8. The system of claim 1, wherein the plurality of wireless devices include personal digital assistants.

9. The system of claim 1, wherein the plurality of wireless devices include cellular telephones.

10. A system, comprising:
an input that receives power from a primary power source;
a plurality of outputs coupled to the input, the plurality of outputs being adapted to provide power to a plurality of equipment;
means for receiving control, configuration and status information from a plurality of wireless devices and for generating a plurality of control signals representing the control, configuration and status information; and
a processor coupled to the means for receiving control, configuration and status information and to the plurality of outputs, the processor being adapted to receive and respond to the plurality of control signals by actuating the plurality of outputs.

11. The system of claim 10, further including a means for controlling the outputs, the means for controlling the outputs being coupled between the input and the plurality of outputs, the means for controlling the outputs being further coupled between the processor and the outputs.

12. The system of claim 11, wherein the means for controlling the outputs includes a plurality of switches coupled to the input, to the plurality of outputs and to the processor.

13. The system of claim 10, wherein the means for receiving control, configuration and status information operates using a Wireless Mark-Up Language protocol that enables the means for receiving control, configuration and status information to receive the control, configuration and status information from the plurality of wireless devices.

14. The system of claim 10, wherein the means for receiving control, configuration and status information operates using a Simple Network Management protocol that enables the means for receiving control, configuration and status information to receive the control, configuration and status information from a plurality of servers.

15. The system of claim 11, further including an uninterruptible power supply system comprising:
means for providing a secondary power source to the plurality of equipment;
means for sensing the input to detect if the primary power source is below a predetermined threshold; and
means for coupling the secondary power source to the plurality of equipment if the means for sensing the input detects that the primary power source is below the predetermined threshold.

16. The system of claim 11, further including an intelligent power strip comprising:
an elongated housing; and
a plurality of power outlets mounted on the housing, the plurality of power outlets defining the plurality of outputs adapted to provide power to the plurality of electrical equipment.

17. The system of claim 10, wherein the plurality of wireless devices include personal digital assistants.

18. The system of claim 10, wherein the plurality of wireless devices include cellular telephones.

19. A method of controlling a system comprising the steps of:
receiving control, configuration and status information at the system;
generating a plurality of control signals at the system representing the control, configuration and status information; and
communicating the plurality of control signals to a plurality of outputs located on the system to selectively actuate the outputs to selectively power-on or power-off a plurality of equipment or components coupled to the plurality of outputs.
